(19) United States
(12) Patent Application Publication
(10) Pub. No.: US 2007/0237682 A1
(43) Pub. Date: Oct. 11, 2007

(54) FLUID INJECTION APPARATUS AND FABRICATION METHOD THEREOF

(75) Inventors: Wen Pin Chuang, Kaohsiung County (TW); Chung Cheng Chou, Taoyuan County (TW)

Correspondence Address: QUINTERO LAW OFFICE, PC, 2210 MAIN STREET, SUITE 200, SANTA MONICA, CA, 90405, US

(73) Assignee: BENQ CORPORATION, Taoyuan (TW)

(21) Appl. No.: 11/733,648

(22) Filed: Apr. 10, 2007

(30) Foreign Application Priority Data
Apr. 11, 2006 (TW) TW95112802

(51) Int. Cl. B01L 3/02

(52) U.S. Cl. 422/100

(57) ABSTRACT

A method for forming a fluid injection apparatus is disclosed. A first photosensitive macromolecule layer is formed on a substrate. The first photosensitive macromolecule layer is exposed to light of a first wavelength range using a first mask with pattern of a fluid chamber. A second photosensitive macromolecule layer is formed overlying the first photosensitive macromolecule layer. The second photosensitive macromolecule layer is exposed to light of a second wavelength range using a second mask with pattern of a nozzle, wherein the first wavelength range does not substantially interfere with the second wavelength range. The first photosensitive macromolecule layer and the second photosensitive macromolecule layer are developed to define a fluid chamber overlying the substrate and a nozzle in the second photosensitive macromolecule layer in a single development step.

### BACKGROUND OF THE INVENTION

1. Field of the Invention

The invention relates to a fluid injection apparatus and fabrication methods thereof, and in particular to a micro-fluid injection apparatus and fabrication methods thereof.

2. Description of the Related Art

Micro-fluid injection is widely used in digital applications such as inkjet printers or others. With development of micro-system engineering, micro-fluid injection apparatuses are further used in other applications, such as fuel injection systems, cell sorting, drug delivery systems, print lithography or micro-jet propulsion systems.

FIG. 1A˜FIG. 1B show a method for forming a conventional monolithic fluid injection apparatus 100. Referring to FIG. 1A, a substrate 102 is provided. A patterned sacrificial layer 104 is formed on a first side 101 of the substrate 102. Next, a structural layer 106 is formed to cover the sacrificial layer 104 and the first side 101 of the substrate 102. A mask layer 108 is formed on a second side 103 of the substrate 102.

Referring to FIG. 1B, the mask layer 108 is patterned by lithography to form an opening. The substrate 102 is then etched using the patterned mask layer 108 as an etching mask to form a manifold 110 exposing the sacrificial layer 104. Next, the sacrificial layer 104 is removed through the manifold 110 by etching to form a fluid chamber 112. In the conventional technology, the sacrificial layer 104 is formed of dielectric materials, and due to the intrinsic characteristics of dielectric materials thereof, deposition to a sufficient thickness of sacrificial layer 104 can be very difficult, such that fluid chamber 112 formed by removal of the sacrificial layer 104 is too small. In addition, the dielectric sacrificial layer 104 and the structural layer 106 including dielectric or metal materials are not easily etched or removed. Therefore, the process for forming a conventional fluid injection apparatus is relatively complicated.

### BRIEF SUMMARY OF THE INVENTION

A detailed description is given in the following embodiments with reference to the accompanying drawings. These and other problems are generally solved or circumvented, and technical advantages are generally achieved, by preferred illustrative embodiments of the invention, which provide a fluid injection apparatus.

A method for forming a fluid injection apparatus is disclosed. A patterned macromolecule sacrificial layer is formed on a substrate. A macromolecule structural layer is formed on the substrate, and covers the patterned macromolecule sacrificial layer. The macromolecule structural layer is patterned to form a nozzle, wherein a surface of the patterned macromolecule sacrificial layer in the nozzle is exposed. The patterned macromolecule sacrificial layer is removed to form a fluid chamber, ameliorating possible process incompatibility with the macromolecule structural layer.

Another a method for forming a fluid injection apparatus is disclosed in which a first photosensitive macromolecule layer is formed on a substrate. The first photosensitive macromolecule layer is exposed to light of a first wavelength range using a first mask with pattern of a fluid chamber. A second photosensitive macromolecule layer is formed overlying the first photosensitive macromolecule layer. The second photosensitive macromolecule layer is exposed to light of a second wavelength range using a second mask with pattern of a nozzle, wherein the first wavelength range does not substantially interfere with the second wavelength range. The first photosensitive macromolecule layer and the second photosensitive macromolecule layer are developed to define a fluid chamber overlying the substrate and a nozzle in the second photosensitive macromolecule layer in a same developing step.

The invention further provides a fluid injection apparatus, comprising a substrate, a sidewall structural layer disposed thereon, and a top structural layer disposed overlying the sidewall structural layer, wherein the sidewall structural layer and the top structural layer form a fluid chamber of the fluid injection apparatus, and the sidewall structural layer comprises a first photoresist which substantially reacts to only a light of a first wavelength range, the top structural layer comprises a second photoresist which substantially reacts to only light of a second wavelength range, and the first wavelength range does not substantially interfere with the second wavelength range.

### BRIEF DESCRIPTION OF THE DRAWINGS

The invention can be more fully understood by reading the subsequent detailed description and examples with references made to the accompanying drawings, wherein:

FIG. 1A˜FIG. 1B show a method for forming a conventional monolithic fluid injection apparatus 100.

FIG. 2A˜FIG. 2C show intermediate cross sections of a fluid injection apparatus of an embodiment of the invention.

FIG. 3A˜FIG. 3C show intermediate cross sections of a fluid injection apparatus of another embodiment of the invention.

FIG. 4A˜FIG. 4D show a method for forming a fluid injection apparatus of another embodiment of the invention.

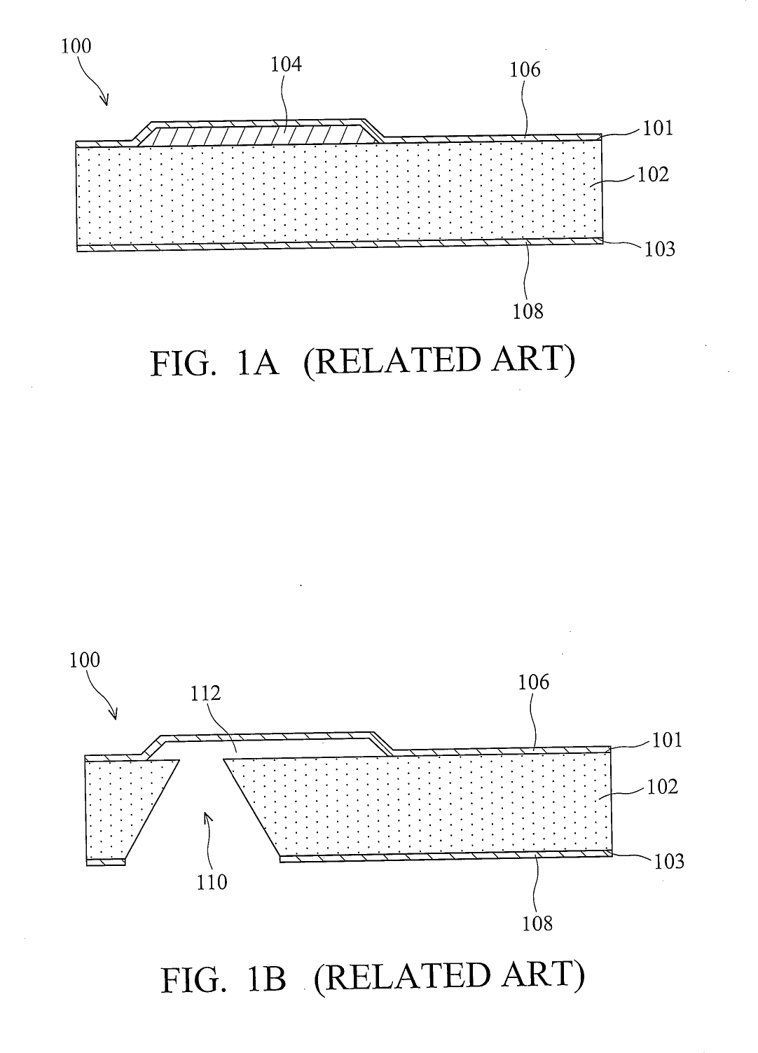

### DETAILED DESCRIPTION OF THE INVENTION

The following description discloses the best-contemplated mode of carrying out the invention. This description is made for the purpose of illustrating the general principles of the invention and should not be taken in a limiting sense. The scope of the invention is best determined by reference to the appended claims.

In this specification, expressions such as “overlying the substrate”, “above the layer”, or “on the film” simply denote a relative positional relationship with respect to the surface of the base layer, regardless of the existence of intermediate layers. Accordingly, these expressions may indicate not only the direct contact of layers, but also, a non-contact state of one or more laminated layers.

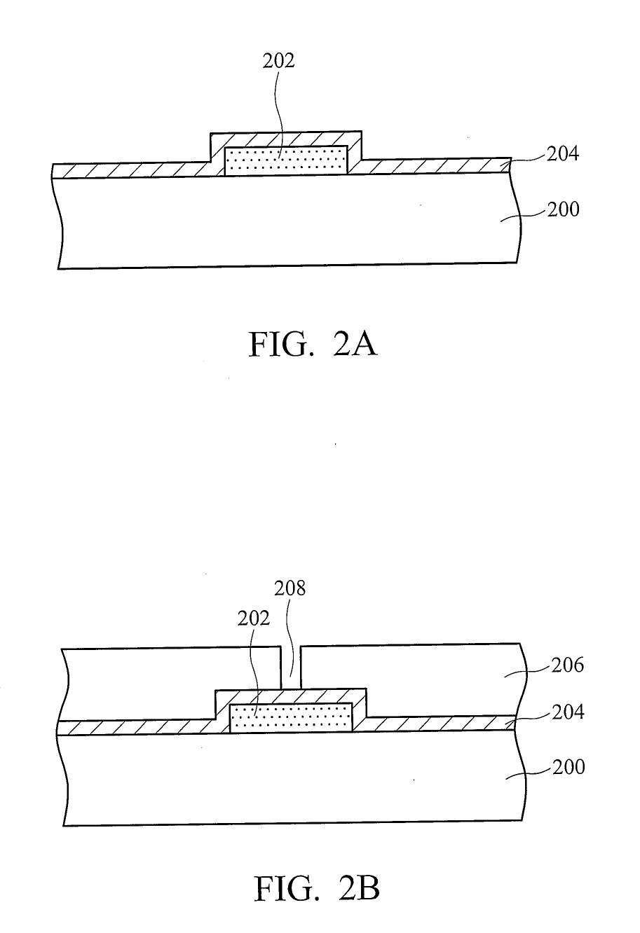

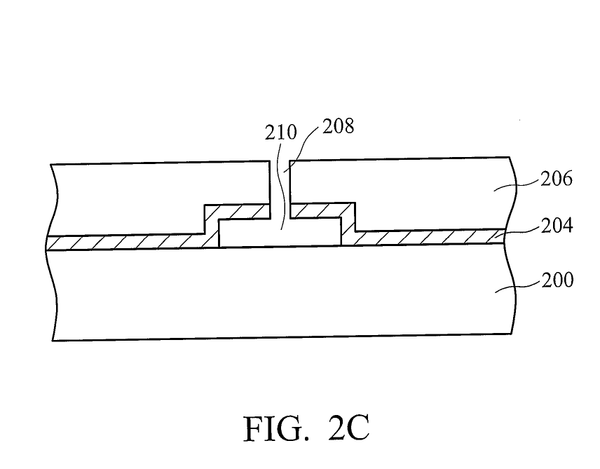

FIG. 2A˜FIG. 2C show intermediate cross sections of a fluid injection apparatus of an embodiment of the invention. Referring to FIG. 2A, a substrate 200 is provided. A patterned macromolecule sacrificial layer 202 is formed on the substrate 200. Next, a barrier layer 204, comprising metal or dielectric materials, is deposited on the macromolecule sacrificial layer 202 and the substrate 200 to avoid process incompatibility between the macromolecule sacrificial layer 202 and a macromolecule structural layer formed in subsequent steps.

Referring to FIG. 2B, a macromolecule structural layer 206 is formed on the barrier layer 204, and then patterned to form a nozzle 208. Referring to FIG. 2C, a portion of the barrier layer 204 in the nozzle 208 is removed, and a portion of the macromolecule sacrificial layer 202 is removed to form a fluid chamber 210. Note that the barrier layer 204 must be integrated with the macromolecule sacrificial layer 202 and the macromolecule structural layer 204. As well, the layers 202, 204 and 206 must be immiscible in chemical and mechanical aspects. For example, in mechanical aspect, thermal expansion coefficients of the layers 202, 204 and 206 must match. In addition, the layers 202, 204 and 206 must have good adhesion therebetween. Consequently, selection of the barrier layer 204 is important.

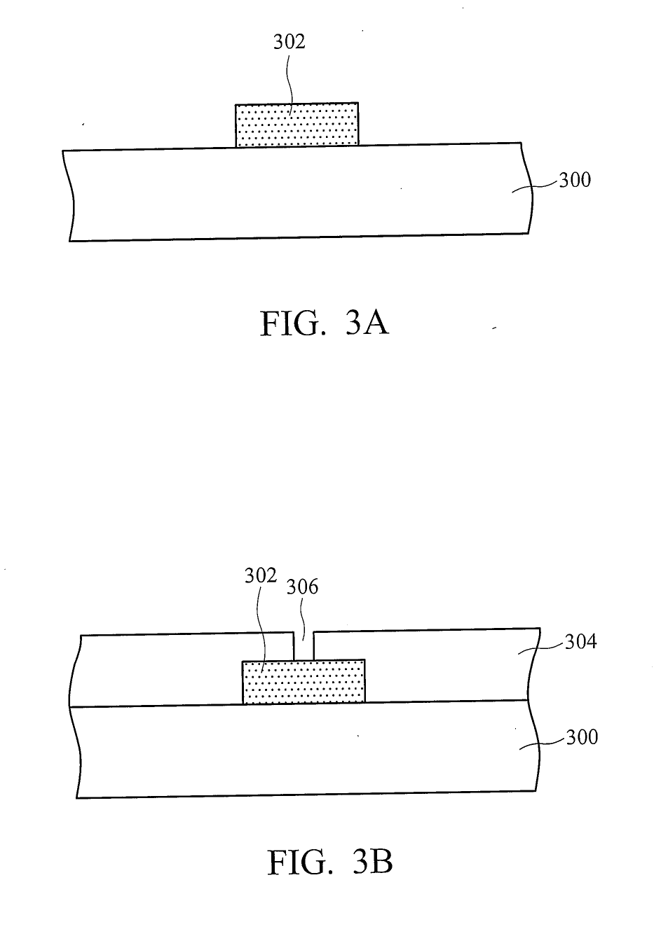

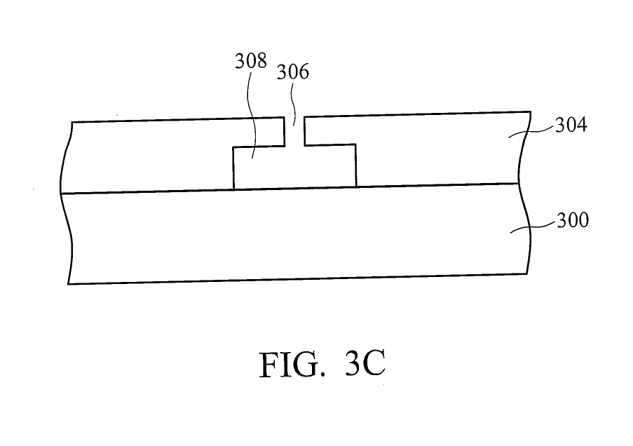

In order to eliminate difficulty of selecting the barrier layer 204, and issues of peeling of the barrier layer 204 and/or other issues generated when removing the barrier layer 204, a method for forming a fluid injection apparatus is provided, as shown in FIG. 3A˜FIG. 3C. Referring to FIG. 3A, a substrate 300 is provided. The substrate 300 can be a semiconductor substrate, such as silicon. The invention, however, is not limited thereto. The substrate 300 can be a glass substrate, or formed by other materials. Note that the substrate 300 can comprise a fluid driving device, such as heater, and/or a fluid controlling device, such as a transistor, in which the fluid driving device and the fluid controlling device is not shown in the figures for simplicity. The driving device and the controlling device can be arranged and fabricated according to product spec or process window as is known in the art.

Next, a macromolecule layer (not shown) is formed on the substrate 300 by spin coating, and then patterned by conventional lithography and etching to form a macromolecule sacrificial layer 302. Referring to FIG. 3B, a macromolecule structural layer 304 is formed to cover the macromolecule sacrificial layer 302, wherein a portion of the macromolecule structural layer 304 is disposed on the substrate 300, and another portion of the macromolecule structural layer 304 directly contacts the macromolecule sacrificial layer 302. Preferably, the macromolecule sacrificial layer 302 comprises process compatibility with the macromolecule structural layer 304. The fluid injection apparatus can thus omit a barrier layer interposed between the macromolecule sacrificial layer 302 and the macromolecule structural layer 304.

More preferably, the macromolecule sacrificial layer 302 is photoresist ODUR produced by TOKYO OHKAKOGYO, primarily comprising PMIPK, and the macromolecule structural layer 304 photoresist SU-8 produced by Microchem, primarily comprising Epoxy Resin. The macromolecule structural layer 304 is patterned to form a nozzle 306, and a surface of the macromolecule sacrificial layer 302 is exposed.

Referring to FIG. 3C, the macromolecule sacrificial layer 302 is removed through the nozzle 306 to form a fluid chamber 308. In this embodiment, since both the macromolecule sacrificial layer 302 and the macromolecule structural layer 304 are formed of macromolecule materials, removal of layers 302 and 304 can be achieved by development or stripping, whereby the process is simpler and cost lower. Further, since a barrier is not utilized in the method for forming a fluid injection apparatus of the embodiment, peeling of the barrier layer and/or issues generated from removing the barrier layer are avoided.

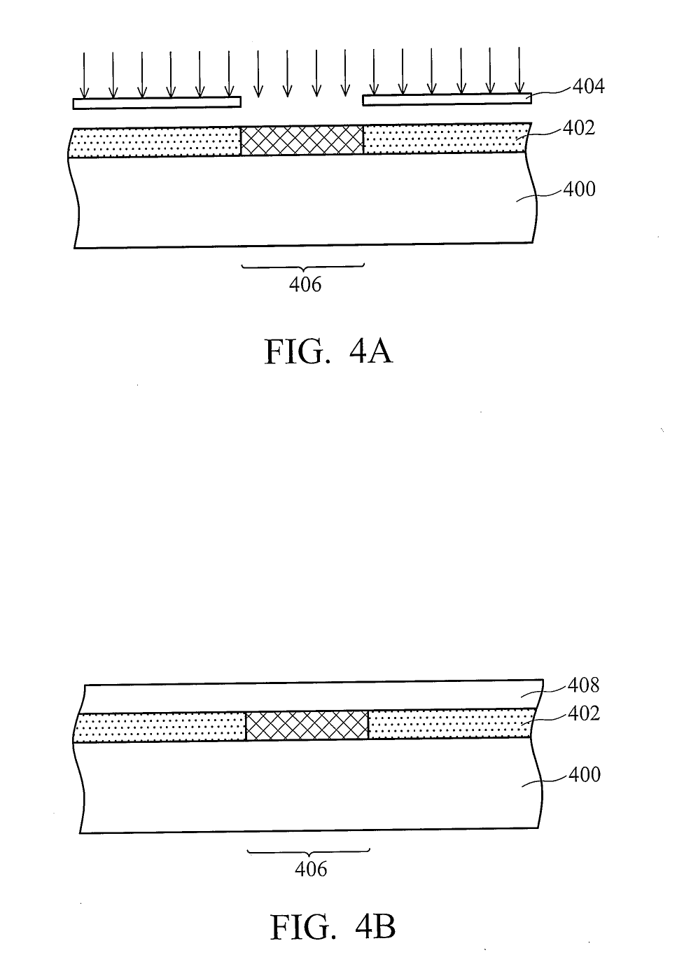

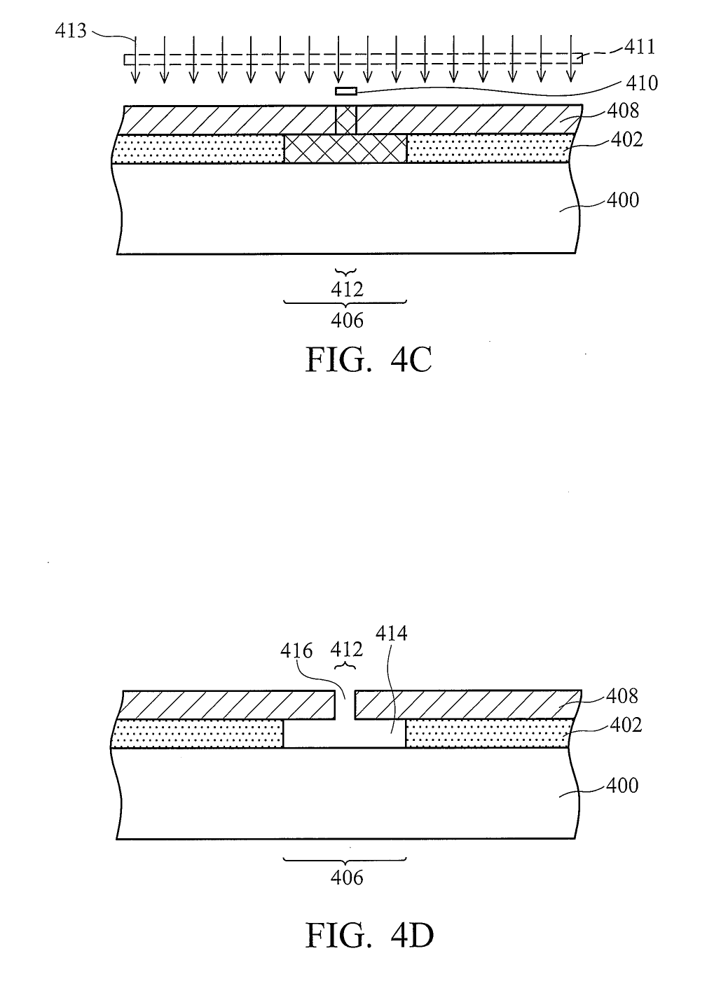

FIG. 4A˜FIG. 4D show a method for forming a fluid injection apparatus of another embodiment of the invention. Referring to FIG. 4A, a substrate 400 is provided. The substrate 400 can be a semiconductor substrate, such as silicon. The invention, however, is not limited thereto. The substrate 400 can be a glass substrate, or formed by other materials. Note that the substrate 400 can comprise a fluid driving device, such as heater, and/or a fluid controlling device, such as a transistor. The fluid driving device and the fluid controlling device is not shown in the figure for simplicity. The devices can be arranged and fabricated according product spec or process window as known in the art.

Next, a first photosensitive macromolecule layer 402 is formed on the substrate 400 by, for example spin coating. Thereafter, the first photosensitive macromolecule layer 402 is defined by an exposing using a mask 404. In an embodiment of the invention, when the first photosensitive macromolecule layer 402 is a positive photoresist, a first area beyond a second area 406 predetermined to form a fluid chamber is covered by the mask 404, and a portion of the first photosensitive macromolecule layer 402 in the second area is exposed. Preferably, the first photosensitive macromolecule layer 402 can only react with light of a first wavelength range. For example, the first photosensitive macromolecule layer 402 can only react with light of wavelength less than 350 nm. Note that the first photosensitive macromolecule layer 402 is only exposed, but not developed.

Referring to FIG. 4B, a second photosensitive macromolecule layer 408 is formed on the exposed first photosensitive macromolecule layer 408 by, for example spin coating. Next, referring to FIG. 4C, when the second photosensitive macromolecule layer 408 is a negative photoresist, a third area predetermined to form a nozzle is covered by a mask 410, and a portion of the second photosensitive macromolecule layer 408 in a fourth area beyond the third area 412 is exposed. Preferably, the second photosensitive macromolecule layer 408 can only react with light of a second wavelength range, not interfering with the first wavelength range. As well, the first photosensitive macromolecule layer 402 exhibits no interference when exposed to light in a wavelength range which the second photosensitive macromolecule layer 408 can react.

Preferably, the second wavelength range does not overlap with the first wavelength range. For example, the first photosensitive macromolecule layer 402 can only react with light having wavelength less than 350 nm, and the second photosensitive macromolecule layer 408 only with light of wavelength exceeding 350 nm.

In addition, in another embodiment of the invention, the second photosensitive macromolecule layer 408 is exposed by light source 413 with full wavelength range, filtered by light filter 411 to filter out a wavelength range with which the second photosensitive macromolecule layer 408 can react. Thus, only the second photosensitive macromolecule layer 408 is reacted by irradiating the light 413 through light filter 411. Consequently, the first photosensitive macromolecule layer 402 is not affected when the second photosensitive macromolecule layer 408 is exposed to define a nozzle. For example, the light filter 411 can be UV-36 produced by HOYA CO, which can filter out ultraviolet light of wavelength less than 350 nm. Since the first photosensitive macromolecule layer 402 can only react with ultraviolet light of wavelength less than 350 nm, when exposing the second photosensitive macromolecule layer 408 to form a nozzle, the filtered light only enhance the second photosensitive macromolecule layer 408 to have a reaction, not affecting the first photosensitive macromolecule layer 402.

Note that the steps described require a specific type first photosensitive macromolecule layer 402 and a second photosensitive macromolecule layer 408. For example, the first photosensitive macromolecule layer 402 can be a photoresist ODUR, and the second photosensitive macromolecule layer 408 a photoresist SU-8 or AZ, wherein the photoresist ODUR can react with ultraviolet light of wavelength less than about 350 nm, and the photoresist SU-8 or AZ substantially can only react with light having wavelength exceeding about 350 nm. In addition, the first photosensitive macromolecule layer 402 and the second photosensitive macromolecule layer 408 can be a photoresist having the same primary composition and structure, such as SU-8, but with different photo sensitive materials asses to have a different exposure specification.

Referring to FIG. 4D, after the exposure steps described, since the bond of first photosensitive macromolecule layer 402 in the area predetermined to form a fluid chamber and the second photosensitive macromolecule layer 408 in the area predetermined to form a nozzle is relatively week, these portions of the first photosensitive macromolecule layer 402 and the second photosensitive macromolecule layer 408 can be removed to form the fluid chamber and the nozzle in a single development step. Thus, a fluid chamber 414 and a nozzle 416 are formed in a single step, wherein the developed first photosensitive macromolecule layer 402 can act as a sidewall structural layer, and the developed second photosensitive macromolecule layer 408 can act as a top structural layer (or a nozzle plate) of a fluid injection apparatus of an embodiment of the invention.

According to the embodiment described, since the first photosensitive macromolecule layer 402 and the second photosensitive macromolecule layer 408 can only react with light of different wavelength ranges, the fluid chamber 414 and the nozzle 416 can be formed in a single development step. Thus, the process steps are simplified and the process duration is reduced. In addition, in another embodiment of the invention, a barrier layer between the macromolecule sacrificial layer and the macromolecule structural layer can be omitted by choosing a specific macromolecule sacrificial layer and a macromolecule structural layer, thus avoiding issues originating with the barrier layer.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for forming a fluid injection apparatus, comprising:
providing a substrate;
forming a patterned macromolecule sacrificial layer on the substrate;
forming a macromolecule structural layer on the substrate, wherein the macromolecule structural layer covers the patterned macromolecule sacrificial layer;
patterning the macromolecule structural layer to form a nozzle, wherein a surface of the patterned macromolecule sacrificial layer in the nozzle is exposed; and
removing the patterned macromolecule sacrificial layer to form a fluid chamber, wherein the patterned macromolecule sacrificial layer is substantially process compatible with the macromolecule structural layer.

2. The method for forming a fluid injection apparatus as claimed in claim 1, wherein the patterned macromolecule sacrificial layer comprises PMIPK.

3. The method for forming a fluid injection apparatus as claimed in claim 1, wherein the patterned macromolecule structural layer comprises Epoxy Resin.

4. The method for forming a fluid injection apparatus as claimed in claim 1, wherein removal of the patterned macromolecule sacrificial layer is accomplished by development or stripping.

5. The method for forming a fluid injection apparatus as claimed in claim 1, wherein the patterned macromolecule sacrificial layer is a positive photoresist.

6. The method for forming a fluid injection apparatus as claimed in claim 1, wherein the patterned macromolecule structural layer is a negative photoresist.

7. A method for forming a fluid injection apparatus, comprising:
providing a substrate;
forming a first photosensitive macromolecule layer on the substrate;
exposing the first photosensitive macromolecule layer to light of a first wavelength range using a first mask with pattern of a fluid chamber;
forming a second photosensitive macromolecule layer overlying the first photosensitive macromolecule layer;
exposing the second photosensitive macromolecule layer to light of a second wavelength range using a second mask with pattern of a nozzle, wherein the first wavelength range does not substantially interfere with the second wavelength range; and
developing the first photosensitive macromolecule layer and the second photosensitive macromolecule layer to define a fluid chamber overlying the substrate and a nozzle in the second photosensitive macromolecule layer in a single developing step.

8. The method for forming a fluid injection apparatus as claimed in claim 7, wherein exposure of the second photosensitive macromolecule layer to light of a second wavelength range using a second mask with pattern of a nozzle comprises:
providing a light source having a full wavelength range;
filtering light from the light source to generate light of a second wavelength range; and
exposing the second photosensitive macromolecule layer to the light of the second wavelength range using a second mask with a pattern of a nozzle

9. The method for forming a fluid injection apparatus as claimed in claim 7, wherein the first photosensitive macromolecule layer reacts only to the light of the first wavelength range, and the second photosensitive macromolecule layer reacts only to the light of the second wavelength range.

10. The method for forming a fluid injection apparatus as claimed in claim 7, wherein the first photosensitive macromolecule layer is not substantially affected when exposing the second photosensitive macromolecule layer to the light of the second wavelength range using the second mask a with pattern of a nozzle.

11. The method for forming a fluid injection apparatus as claimed in claim 7, wherein the first wavelength range is substantially less than 350 nm.

12. The method for forming a fluid injection apparatus as claimed in claim 7, wherein the second wavelength range substantially exceeds 350 nm.

13. The method for forming a fluid injection apparatus as claimed in claim 7, wherein the first photosensitive macromolecule layer is a photoresist ODUR.

14. The fluid injection apparatus as claimed in claim 7, wherein the second photosensitive macromolecule layer is a photoresist AZ or SU-8.

15. The fluid injection apparatus as claimed in claim 8, wherein the light filter is produced by HOYA CO.

16. A fluid injection apparatus, comprising:
a substrate;
a sidewall structural layer disposed overlying the substrate; and
a top structural layer disposed overlying the sidewall structural layer, wherein the sidewall structural layer and the top structural layer form a fluid chamber of the fluid injection apparatus, and the sidewall structural layer comprises a first photoresist which substantially only reacts to light with a first wavelength range, the top structural layer comprises a second photoresist which substantially only reacts to light of a second wavelength range, and the first wavelength range does not substantially interfere with the second wavelength range.

17. The fluid injection apparatus as claimed in claim 16, wherein first photoresist is ODUR.

18. The fluid injection apparatus as claimed in claim 16, wherein second photoresist is AZ or SU-8.

19. The fluid injection apparatus as claimed in claim 16, wherein the fluid injection apparatus further comprises a fluid driving device disposed overlying the substrate to drive a fluid in the fluid chamber, and the top structural layer comprises a nozzle.

20. The fluid injection apparatus as claimed in claim 16, wherein the sidewall structural layer and the top structural layer are photoresists having the same primary composition, but with different photo sensitive materials added to provide different exposure specifications.
